(19) United States
(12) Patent Application Publication
(10) Pub. No.: US 2009/0198638 A1
(43) Pub. Date: Aug. 6, 2009

(54) PRESENCE COMBINING APPARATUS AND PRESENCE COMBINING METHOD

(75) Inventor: Kenichi SAKURAI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/343,474

(22) Filed: Dec. 23, 2008

(30) Foreign Application Priority Data
Dec. 25, 2007 (JP) 2007-332320

(51) Int. Cl. G06N 5/02; G06F 15/173

(52) U.S. Cl. 706/47; 709/224

(57) ABSTRACT

A presence combining apparatus comprising collecting means for collecting the items of presence information managed in formats of the individual presence sources by connecting individually to a plurality of different presence sources that manage items of presence information indicating states of elements;
converting means for converting the items of presence information collected by the collecting means into items of primary presence information in a common format that does not depend on the presence sources; storage means for storing the items of primary presence information obtained by conversion performed by the converting means; and generation means for generating secondary presence information by combining the items of primary presence information, which are stored by the storage means, in accordance with a rule.

### CROSS-REFERENCE TO RELATED APPLICATION

This application is based upon and claims the benefit of priority of the prior Japanese Patent Application No. 2007-332320, filed on Dec. 25, 2007, the entire contents of which are incorporated herein by reference.

### BACKGROUND

The present invention relates to a presence combining apparatus, and a presence combining method, and more particularly, to a presence combining apparatus, and a presence combining method which can efficiently collect items of presence information from a plurality of different presence sources and combine the items of presence information in a format that can be easily employed by an application.

### DESCRIPTION OF THE RELATED ART

In recent years, there has been available a service that associates an element such as a person, a thing, or a device in a network with information called presence information that indicates the state thereof, manages the presence information of each element, and makes it possible to share the presence information of each element in the network. Specifically, for example, an Internet Protocol (IP) messenger associates presence information indicating, for example, “on the phone,” “in a meeting,” or “on a business trip,” with each user belonging to a specific network, such as an in-company local area network (LAN). Each user in the network can be notified of the state of another user. Also, in a wireless communication system such as a mobile phone network, each mobile phone is associated with presence information which is location information on the basis of location information of a base station within a communication range of the mobile phone and information obtained using the Global Positioning System (GPS).

Such items of presence information are communicated and held using unique protocols and data formats of individual presence sources such as systems and networks and managed in an integrated manner in the individual presence sources. Specifically, one available presence source manages presence information using a protocol such as Session Initiation Protocol (SIP) for Instant Messaging and Presence Leveraging Extensions (SIMPLE) defined in Request for Comment (RFC) 3856 of Internet Engineering Task Force (IETF) and a data format such as Common Profile for Instant Messaging (CPIM) defined in RFC 3862 of the same IETF.

Therefore, when presence information is to be employed by an application, for example, items of presence information based on protocols and data formats that are unique to individual presence sources are collected, and the application applies processing to the collected presence information. For example, Japanese Unexamined Patent Application Publication No. 2006-277243 discloses the technique of selecting, on the basis of a notification policy set by a user, presence information, a notification of which is to be sent to another user, collecting the selected presence information using a server, and sending a notification of the selected presence information to the other user.

However, as has been described above, since individual presence sources manage items of presence information using unique protocols and data formats, it has been difficult to obtain items of presence information from a plurality of different presence sources and to provide a service using these items of presence information. That is, for example, an application that employs items of presence information obtained from a plurality of different presence sources in a crossover manner is required to connect to the presence sources using apparatuses and programs corresponding to the protocols unique to the individual presence sources. Similarly, it becomes necessary for the application to analyze the items of presence information managed using data formats that are unique to the individual presence sources and to execute processing while absorbing differences among the data formats. Therefore, the use of items of presence information collected from a plurality of different presence sources involves an increase in the amount of development of the application.

Alternatively, a program on a presence source side may be modified to make it possible to exchange presence information in a format that can be employed by the application. In particular, when a presence source is a known presence source, the presence source in operation must be changed only for the purpose of enabling the application to employ the presence information, which is inefficient.

Meanwhile, a plurality of different presence sources often manage related items of presence information. By employing these items of presence information in a crossover manner, a wide range of services can be realized. Therefore, there has been a strong demand for combining items of presence information and using the combined presence information.

In view of the foregoing circumstances, it is an object of the present invention to provide a presence combining apparatus and a presence combining method that may efficiently collect items of presence information from a plurality of different presence sources and combine the items of presence information in a format that can be easily employed by an application.

### SUMMARY

A presence combining apparatus comprising collecting means for collecting the items of presence information managed in formats of the individual presence sources by connecting individually to a plurality of different presence sources that manage items of presence information indicating states of elements; converting means for converting the items of presence information collected by the collecting means into items of primary presence information in a common format that does not depend on the presence sources; storage means for storing the items of primary presence information obtained by conversion performed by the converting means; and generation means for generating secondary presence information by combining the items of primary presence information, which are stored by the storage means, in accordance with a rule.

### BRIEF DESCRIPTION OF THE DRAWINGS

FIG. 1 is a block diagram illustrating a structure of main portions of a presence combining apparatus according to a first embodiment;

FIGS. 2A and 2B are diagrams illustrating specific examples of presence information according to the first embodiment;

FIG. 3 is a diagram illustrating a specific example of an identification (ID) conversion table according to the first embodiment;

FIGS. 4A and 4B are diagrams illustrating specific examples of a primary presence table according to the first embodiment;

FIGS. 5A to 5D are diagrams illustrating specific examples of a secondary presence generation rule according to the first embodiment;

FIGS. 6A and 6B are diagrams illustrating specific examples of filter information according to the first embodiment;

FIG. 7 is a flowchart illustrating a presence combining process according to the first embodiment;

FIGS. 8A and 8B are sequence diagrams illustrating specific examples of collecting presence information according to the first embodiment;

FIG. 9 is a sequence diagram illustrating generation of secondary presence information according to the first embodiment;

FIG. 10 is a diagram illustrating a specific example of generation of secondary presence information according to the first embodiment;

FIGS. 11A and 11B are diagrams illustrating a specific example of providing presence information according to the first embodiment;

FIGS. 12A and 12B are diagrams illustrating another specific example of providing presence information according to the first embodiment;

FIG. 13 is a block diagram illustrating a structure of main portions of a presence combining apparatus according to a second embodiment;

FIG. 14 is a diagram illustrating a specific example of a related presence source table according to the second embodiment;

FIG. 15 is a flowchart illustrating a presence combining process according to the second embodiment; and

FIG. 16 is a sequence diagrams illustrating generation of secondary presence information according to the second embodiment.

### DETAILED DESCRIPTION OF THE EMBODIMENTS

The gist of the present invention is, when there is a plurality of presence sources that manages the states of presence associated with elements such as persons and things, to collect identification information and presence information given to each element using a unique protocol in each presence source, and to convert the identification information and the presence information, which are different according to each presence source, into common identification information and common presence information that do not depend on the presence source. Hereinafter, embodiments of the present invention will be described in detail with reference to the drawings.

### First Embodiment

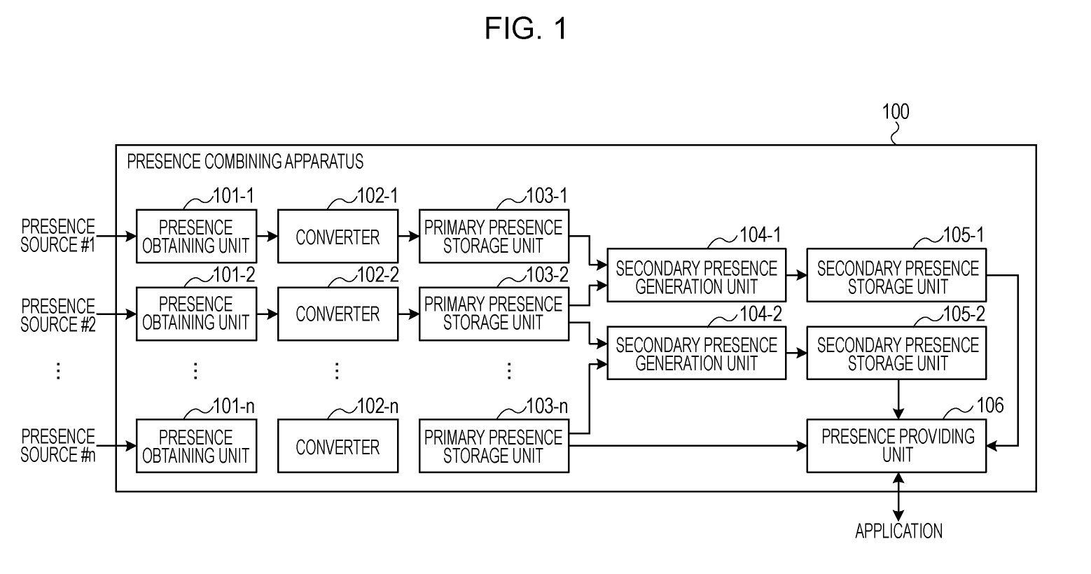

FIG. 1 is a block diagram illustrating a structure of main portions of a presence combining apparatus 100 according to a first embodiment of the present invention. The presence combining apparatus 100 shown in FIG. 1 collects and combines items of presence information from n different presence sources #1 to #n, where n is an integer greater than or equal to 2, and provides the combined presence information to an application. Specifically, the presence combining apparatus 100 includes presence obtaining units 101-1 to 101-n, converters 102-1 to 102-n, primary presence storage units 103-1 to 103-n, secondary presence generation units 104-1 and 104-2, secondary presence storage units 105-1 and 105-2, and a presence providing unit 106.

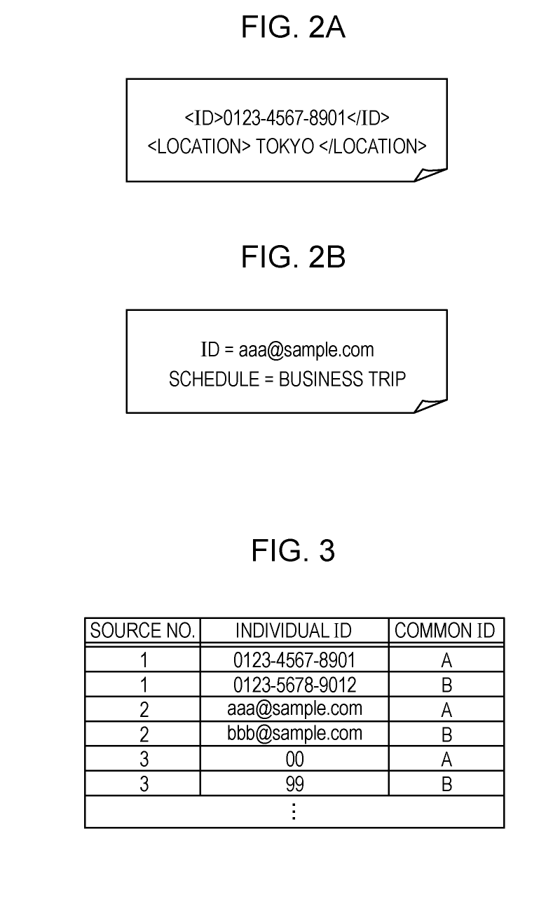

The presence obtaining units 101-1 to 101-n connect to the respective presence sources #1 to #n using protocols used in the presence sources #1 to #n, and obtain items of presence information including the IDs and states of elements in the individual presence sources #1 to #n. On this occasion, the presence obtaining units 101-1 to 101-n obtain items of presence information in formats that are uniquely defined in the respective presence sources (hereinafter called “items of original presence information”). Specifically, for example, the presence obtaining unit 101-1 obtains, from the presence source #1, original presence information storing the ID and state of an element in an XML format, as shown in FIG. 2A. In contrast, for example, the presence obtaining unit 101-2 obtains, from the presence source #2, original presence information storing the ID and state of an element in a text format, as shown in FIG. 2B. The presence obtaining units 101-1 to 101-n output the obtained items of original presence information to the converters 102-1 to 102-n, respectively.

The converters 102-1 to 102-n convert the items of original presence information output from the presence obtaining units 101-1 to 101-n into items of primary presence information in a common format that does not depend on the presence sources. On this occasion, the converters 102-1 to 102-n convert the individual IDs of each presence source included in the original presence information into common IDs. Specifically, the converters 102-1 to 102-n each have an ID conversion table such as that shown in FIG. 3. By referring to the ID conversion table, the converters 102-1 to 102-n determine the common ID of each element from the source number of the presence source and the individual ID used individually in the presence source.

In the example shown in FIG. 3, for example, an element whose individual ID in the presence source #1 is “0123-4567-8901” is given the common ID “A.” Also, for example, an element whose individual ID in the presence source #2 is “aaa@sample.com” is given the common ID “A.” This means that the element whose individual ID in the presence source #1 is “0123-4567-8901” and the element whose individual ID in the second source #2 is “aaa@sample.com” are treated as the same element or as a pair of elements, as in a mobile phone and its user.

Also, the converters 102-1 to 102-n convert the states of elements included in the items of original presence information into a common data format. Specifically, the converters 102-1 to 102-n separate the states of elements included in the items of original presence information into presence kinds and their values. Therefore, for example, the state “<ID>Tokyo</ID>” in the XML format, which is shown in FIG. 2A, is converted into a data format in which the presence kind is “location” and the state (which hereinafter may simply be called “presence” in some cases) is “Tokyo.” Similarly, the state “schedule=business trip” in the text format, which is shown in FIG. 2B, is converted into a data format in which the presence kind is “schedule” and the presence is “business trip.” The converters 102-1 to 102-n store the IDs and the data-format-converted items of primary presence information in the primary presence storage units 103-1 to 103-n, respectively.

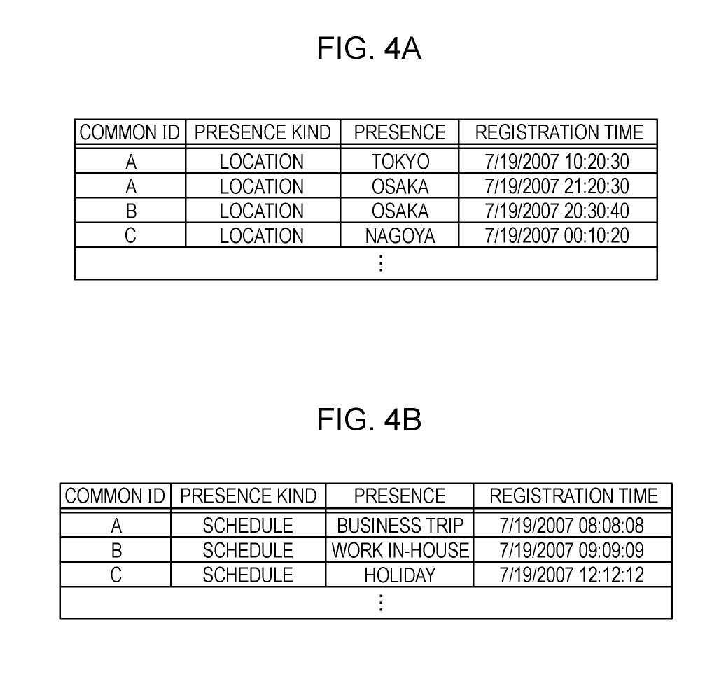

The primary presence storage units 103-1 to 103-n store the presence kind, presence, and registration time in association with the common ID of each element. That is, the primary presence storage units 103-1 to 103-n each include, for example, as shown in FIGS. 4A and 4B, a presence table that stores items of primary presence information obtained by converting items of original presence information. In the examples shown in FIGS. 4A and 4B, FIG. 4A shows a presence table that stores items of primary presence information originated from the presence source #1, which is included in the primary presence storage unit 103-1. This presence table stores items of primary presence information of the presence kind “location”. FIG. 4B shows, for example, a presence table that stores items of primary presence information originated from the presence source #2, which is included in the primary presence storage unit 103-2. This presence table stores items of primary presence information of the presence kind “schedule”.

Further, in the presence table shown in FIG. 4A, regarding elements having the common ID “A”, for example, the presence “Tokyo” is registered at the registration time “Jul. 19, 2007 10:20:30”, and the presence “Osaka” is registered at the registration time “Jul. 19, 2007 21:20:30”. Note that, in FIGS. 4A and 4B, since items of primary presence information of the same presence kind can be obtained from one presence source, each presence table stores items of primary presence information of the same presence kind. Alternatively, the primary presence storage units 103-1 to 103-n may store items of primary presence information of numerous different presence kinds in the same presence table.

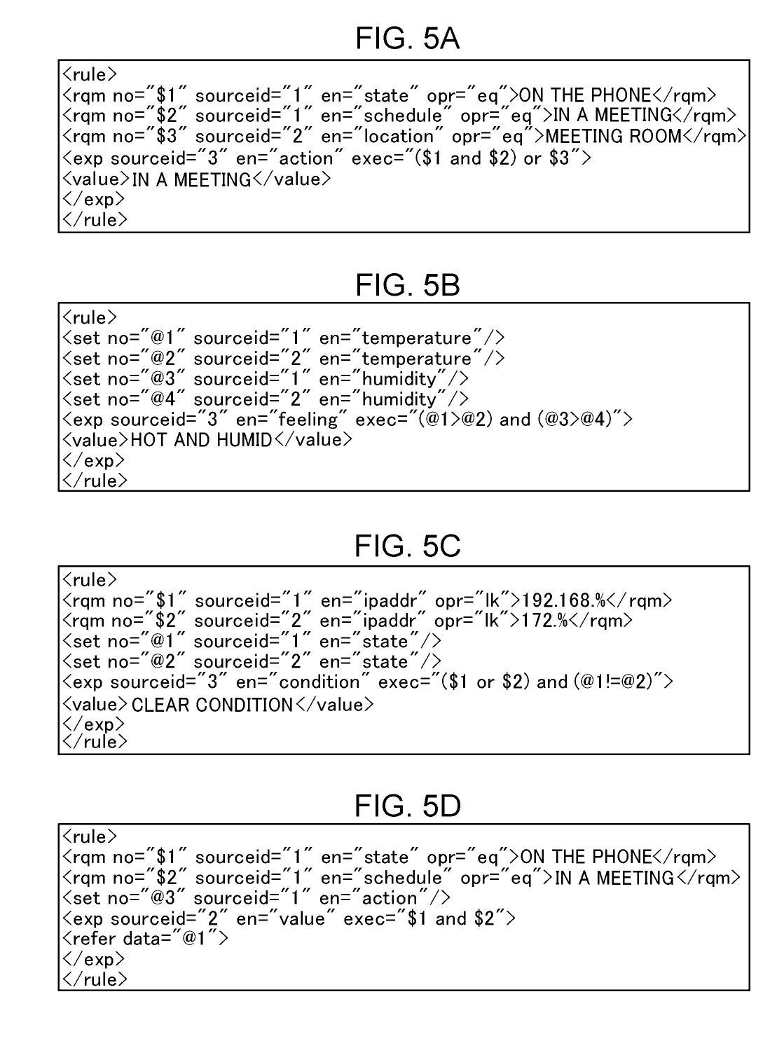

The secondary presence generation units 104-1 and 104-2 combine items of primary presence information stored in the primary presence storage units 103-1 to 103-n to generate secondary presence information. Specifically, the secondary presence generation units 104-1 and 104-2 each hold a secondary presence generation rule, such as those shown in FIGS. 5A to 5D. The secondary presence generation units 104-1 and 104-2 combine items of primary presence information in accordance with the secondary presence generation rule and generate secondary presence information for each common ID made up of presence kinds and items of presence information. The secondary presence generation rules held in the secondary presence generation units 104-1 and 104-2 define, in the case where items of presence information from a new viewpoint can be obtained by using items of primary presence information originated from a plurality of presence sources in a crossover manner, how the items of primary presence information are to be combined.

For example, when items of primary presence information originated from the presence source #1 relate to locations of elements, and items of primary presence information originated from the secondary presence sources #2 relate to schedules of the elements, items of secondary presence information relating to the current actions of the elements can be obtained by combining these items of primary presence information. Specifically, for the elements having the same common ID, when primary presence information including the presence kind “location” and the presence “meeting room” is obtained from the presence source #1, and primary presence information including the presence kind “schedule” and the presence “meeting” is obtained from the presence source #2, by combining these items of primary presence information in accordance with the secondary presence generation rule, secondary presence information indicating the current action, such as the presence kind “action” and the presence “in a meeting”, is obtained.

Such secondary presence generation rules are held in advance in the secondary presence generation units 104-1 and 104-2 in accordance with the type of a presence source connected to the presence combining apparatus 100 and a request from an application. Specific examples of the secondary presence generation rule are written in the XML format in FIGS. 5A to 5D. The first secondary presence generation rule shown in FIG. 5A is a rule that compares primary presence information with a constant value. Parameters in an “rqm” tag include four elements, “no” indicating the number of a definition, “sourceid” indicating the number of a presence table referred to, “en” indicating the presence kind, and “opr” indicating the type of comparison. Types of comparison indicated by “opr” may include “eq” indicating that compared items are equal, a sign of equality, a sign of inequality, and a sign of partial match.

Therefore, the portion “<rqm no=“$1” sourceid=“1” en=“state” opr=“eq”>on the phone</rqm>” in the first secondary presence generation rule in FIG. 5A indicates that, for the presence table whose “sourceid” is “1” (e.g., the presence table stored in the primary presence storage unit 103-1), an arithmetic operation that the presence corresponding to the presence kind “state” is equal to “on the phone” is substituted for “$1”. Then, “exp” defines that, when an arithmetic operation indicated by “exec” is satisfied, secondary presence information becomes a value indicated by “value”. That is, when “($1 and $2) or $3” is satisfied, the first secondary presence generation rule in FIG. 5A defines to write the presence “in a meeting” into the element whose presence kind is “action” in the presence table whose “sourceid” is “3”. Note that it is assumed here that the presence table whose “sourceid” is “3” indicates presence tables that are included in the secondary presence storage units 105-1 and 105-2 and store secondary presence information.

The second secondary presence generation rule shown in FIG. 5B is a rule that compares items of primary presence information with each other. Parameters in a “set” tag include three elements, “no” indicating the number of a definition, “sourceid” indicating the number of a presence table referred to, and “en” indicating the presence kind.

Therefore, the portion “<set no=“@1” sourceid=“1” en=“temperature”/>” in the second secondary presence generation rule in FIG. 5B indicates that, for the presence table whose “sourceid” is “1”, the presence corresponding to the presence kind “temperature” is substituted for “@1”. The portion “exp” prescribes, when “(@1>@2) and (@3>@4)” is satisfied, writing the presence “hot and humid” into the element whose presence kind is “feeling” in the presence table whose “sourceid” is “3”.

The third secondary presence generation rule shown in FIG. 5C is a rule combining the first and second rules. For the presence table whose “sourceid” is “1”, when the value of the presence kind “ipaddr” is equal to “192.168. %” (where “%” indicates a partial match), or, for the presence table whose “sourceid” is “2”, when the condition that the value of the presence kind “ipaddr” is equal to “172. %” and that the values of “state” of two compared items are not equal is satisfied, the third secondary presence generation rule prescribes writing the presence “clear condition” into the element whose presence kind is “condition” in the presence table whose “sourceid” is “3”.

The fourth secondary presence generation rule shown in FIG. 5D is a rule that makes secondary presence information variable. For the presence table whose “sourceid” is “1”, when the value of the presence kind “state” is equal to “on the phone” and the value of the presence kind “schedule” is equal to “in a meeting”, the fourth secondary presence generation rule prescribes writing, into the element whose presence kind is “value” in the presence table whose “sourceid” is “2”, the presence of the presence kind “action” in the presence table whose “sourceid” is “1”. Note that “<refer data=“@1”>” indicates an instruction to write the presence of “@1”. Also, the presence table whose “sourceid” is “2” is a presence table that stores secondary presence information.

Referring back to FIG. 1, the secondary presence storage units 105-1 and 105-2 store secondary presence information generated by the secondary presence generation units 104-1 and 104-2, respectively. Specifically, the secondary presence storage units 105-1 and 105-2 include presence tables similar to those of the primary presence storage units 103-1 to 103-n. These presence tables store the presence kind, presence, and registration time in association with each common ID.

Note that, in FIG. 1, the secondary presence generation unit 104-1 generates secondary presence information from primary presence information stored in the primary presence storage units 103-1 and 103-2, and the secondary presence storage unit 105-1 stores the generated secondary presence information. Similarly, the secondary presence generation unit 104-2 generates secondary presence information from primary presence information stored in the primary presence storage units 103-2 and 103-n, and the secondary presence storage unit 105-2 stores the generated secondary presence information. However, combinations of items of primary presence information serving as a source from which secondary presence information is generated need not necessarily be the same as those shown in FIG. 1. One secondary presence generation unit may combine primary presence information stored in three or more primary presence storage units to generate secondary presence information. Alternatively, two secondary presence generation units may employ primary presence information stored in the same primary presence storage unit in an overlapping manner. Also, in FIG. 1, secondary presence information is generated by combining a plurality of items of primary presence information. Alternatively, for example, higher-order presence information may be generated, such as generating tertiary presence information from a plurality of items of secondary presence information.

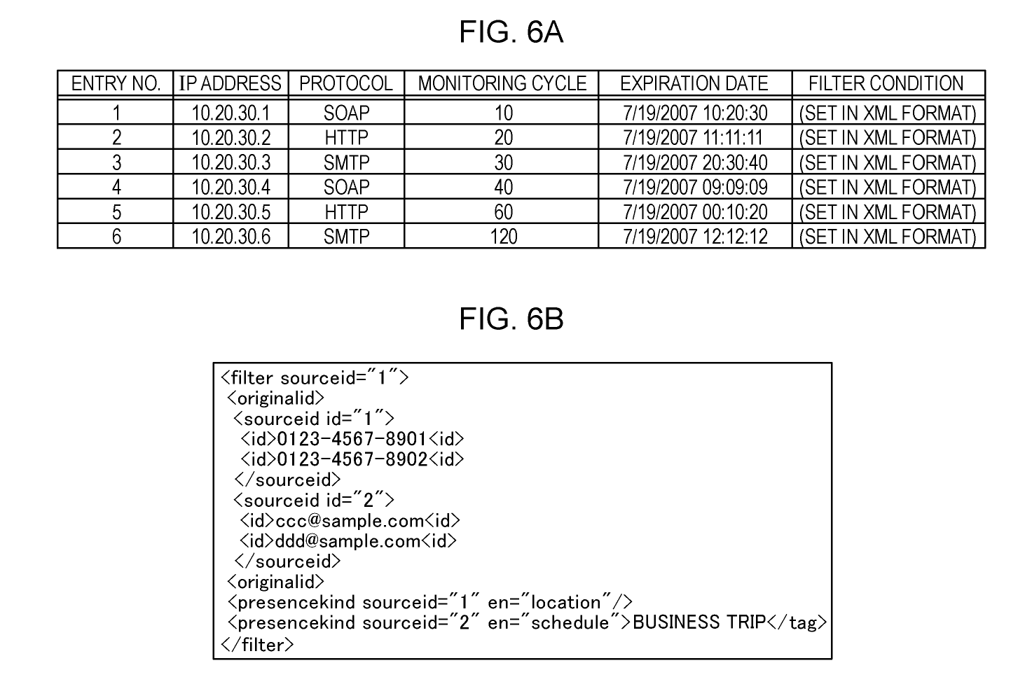

The presence providing unit 106 receives, from an application, filter information including a condition of presence information to be employed by the application, obtains presence information that matches the condition designated by the filter information from the primary presence storage units 103-1 to 103-n and the secondary presence storage units 105-1 and 105-2, and sends a notification of the presence information to the application. Specifically, the presence providing unit 106 includes, as shown in FIGS. 6A and 6B, a filter information table including a plurality of entries of filter information received from applications. While monitoring the primary presence storage units 103-1 to 103-n and the secondary presence storage units 105-1 and 105-2, if there is presence information that matches the filter condition in an entry in the filter information table, the presence providing unit 106 sends a notification of this presence information to a corresponding application.

In FIG. 1, the presence providing unit 106 monitors only the primary presence storage unit 103-n and the secondary presence storage units 105-1 and 105-2 and obtains presence information that matches the conditions. Alternatively, depending on the filter condition in each entry, if necessary, the presence providing unit 106 may monitor the other primary presence storage units 103-1 and 103-2, and the like.

Regarding the filter information table shown in FIG. 6A, an entry whose entry number is 1 will be described by way of example. The IP address of an application that has entered this filter information is “10.20.30.1”. Also, this application specifies to use “Simple Object Access Protocol (SOAP)” as a protocol at the time of sending a notification of presence information, and specifies “ten seconds” as a cycle of monitoring the primary presence storage units 103-1 to 103-3 and the secondary presence storage units 105-1 and 105-2. Therefore, the presence providing unit 106 executes determination, on the basis of the filter condition, of presence information stored in each presence storage unit at intervals of ten seconds, and sends a notification of the determination result to the application whose IP address is “10.20.30.1” using SOAP.

Also, each entry of filter information is given an expiration date specified by an application. The presence providing unit 106 continues monitoring presence information stored in each presence storage unit until the expiration date of each entry. The presence providing unit 106 deletes an entry that has passed the expiration date from the filter information table.

A filter condition indicating a condition of presence information to be employed by an application is written in the XML format, as shown in FIG. 6B, for example. The filter condition shown in FIG. 6B is to specify a notification regarding the tags “<id>0123-4567-8901<id>”, “<id>0123-4567-8902<id>”, “<id>ccc@sample.com<id>”, and “<id>ddd@sample.com<id>”, to each of which “id” is given. Note that the IDs indicated by these tags are individual IDs uniquely used in the individual presence sources. Alternatively, a filter condition may be written using common IDs. “<presencekind sourceid=“1” en=“location”/>” indicates a condition in which the presence of the presence kind “location” has changed in the presence table referred to (e.g., the presence table whose “sourceid” is “1”). “<presencekind sourceid=“2” en=“schedule”>business trip</tag>” indicates a condition in which the presence of the presence kind “schedule” has changed to “business trip” in the presence table referred to (e.g., the presence table whose “sourceid” is “2”). Therefore, when presence information that satisfies the above-described condition is detected, the presence providing unit 106 sends a notification of the detected presence information to the application.

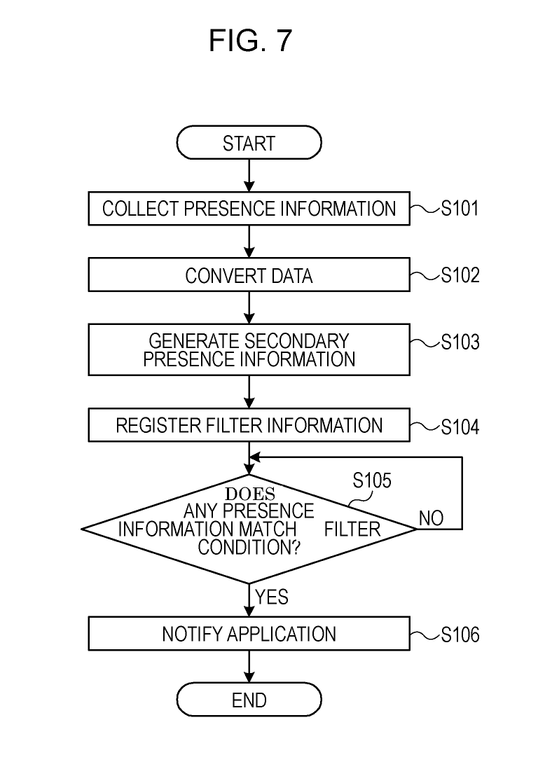

Next, a presence combining process performed by the presence combining apparatus 100 structured as described above will be described with reference to the flowchart shown in FIG. 7.

The presence obtaining units 101-1 to 101-n collect items of original presence information from the individual presence sources #1 to #n, respectively (step S101). These presence obtaining units 101-1 to 101-n are connected to the respective presence sources #1 to #n at connection destinations using unique protocols. The presence obtaining units 101-1 to 101-n obtain items of original presence information of elements without changing the individual IDs and unique data formats in the individual presence sources #1 to #n. Therefore, programs in the presence sources #1 to #n need not be modified only for connections with the presence combining apparatus 100.

The items of original presence information obtained by the presence obtaining units 101-1 to 101-n are converted by the converters 102-1 to 102-n into items of primary presence information having common IDs and a common data format that can be commonly used (step S102). That is, the individual ID of each element is converted into a common ID using the ID conversion table held in each of the converters 102-1 to 102-n, and each item of original presence information is separated into the presence kind and the presence, whereby the original presence information is converted into common primary presence information. Primary presence information obtained by conversion in this manner is stored in the presence table in each of the primary presence storage units 103-1 to 103-n. Accordingly, the primary presence information stored in the primary presence storage units 103-1 to 103-n become common presence information that does not depend on the original presence sources #1 to #n, and items of primary presence information from all the presence sources #1 to #n can be equally handled.

There are two types of presence sources: an autonomous-notification-type presence source that autonomously sends a notification of a change in original presence information of each element to an external device; and a reference-type presence source that does not autonomously send a notification to the external device and is only referred to from the external device. Therefore, depending on whether presence sources connected to the individual presence obtaining units 101-1 to 101-n are autonomous-notification-type or reference-type, original presence information is obtained and converted using a slightly different procedure, which will be described below.

While items of primary presence information converted into a common data format are stored into the primary presence storage units 103-1 to 103-n as occasion calls, the secondary presence generation units 104-1 and 104-2 apply the secondary presence generation rules to generate secondary presence information by combining the items of primary presence information (step S103). That is, the secondary presence generation units 104-1 and 104-2 each hold in advance a secondary presence generation rule that defines original primary presence information and a combining method. The secondary presence generation units 104-1 and 104-2 each combine items of primary presence information originated from different presence sources to generate secondary presence information in a viewpoint different from the individual items of primary presence information. The secondary presence information generated in this manner is stored in the presence table in each of the secondary presence storage units 105-1 and 105-2. The detailed sequence of generating secondary presence information will be described below.

While original presence information is being converted and secondary presence information is being generated, filter information that includes a condition of primary presence information and secondary presence information to be employed by an application is received by the presence providing unit 106 from the application. The received filter information is registered in an entry of the filter information table held in the presence providing unit 106 (step S104). Each entry in the filter information table includes a filter condition that designates presence information to be extracted and an expiration date. Before the expiration date of each filter condition, the presence providing unit 106 refers to the presence information stored in the primary presence storage units 103-1 to 103-n and the secondary presence storage units 105-1 and 105-2 and monitors whether or not there is any presence information that matches the filter condition (step S105).

Methods of referring to presence information that matches the filter condition include an asynchronous referring method in which filter information is registered in the filter information table, and a synchronous referring method in which presence information is referred to at the same time as receiving filter information from an application.

As a result of referring to the presence information, when there is no presence information that matches the filter condition (NO in step S105), monitoring is continued at the cycle designated on an entry-by-entry basis. When presence information that matches the filter condition is detected (YES in step S105), the presence providing unit 106 obtains the corresponding presence information. The presence providing unit 106 sends, to the application, a notification of the presence information which matches the filter condition (step S106). On this occasion, since each entry in the filter information table includes the IP address of a corresponding application and a protocol, a notification of presence information is sent to the application corresponding to the IP address on an entry-by-entry basis using the designated protocol.

Accordingly, the application can obtain items of unique original presence information in a plurality of different presence sources using a unified, common format. Additionally, the application can obtain higher-order presence information generated by combining two or more items of primary presence information. As a result, the application can execute various processes simply by using the obtained presence information. Specific processes performed by the application include, for example, a process of receiving, from the presence combining apparatus 100, when the presence combining apparatus 100 has generated secondary presence information from original presence information regarding the schedule of an element and original presence information regarding the location information of the element, a notification of the secondary presence information indicating that the current location contradicts the schedule, and sending a warning email message to the corresponding element.

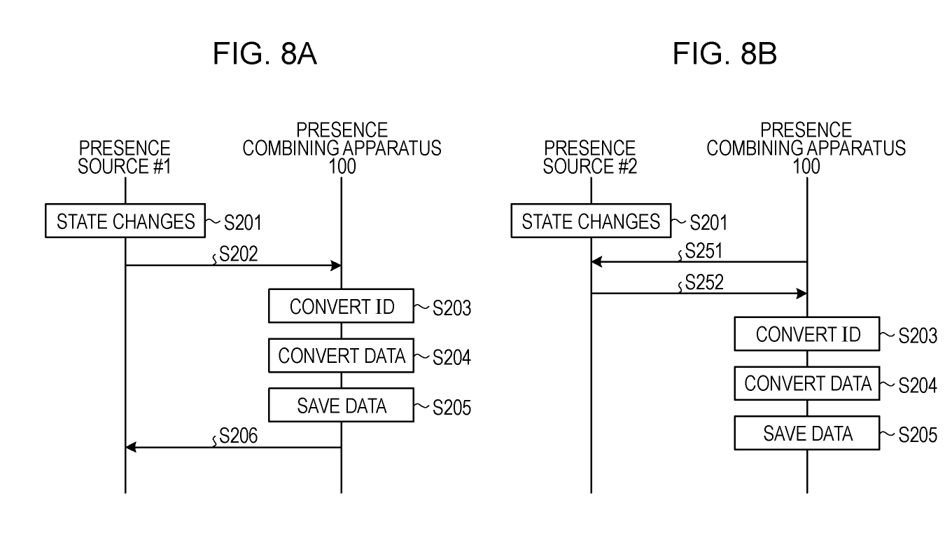

Next, a difference in an original presence collecting operation between the case where a presence source is an autonomous-notification-type presence source and the case where a presence source is a reference-type presence source will be described with reference to FIGS. 8A and 8B. FIG. 8A is a sequence diagram illustrating the operation regarding the presence source #1 which is an autonomous-notification-type presence source, and FIG. 8B is a sequence diagram illustrating the operation regarding the presence source #2 which is a reference-type presence source. In these diagrams, the same operation is given the same reference numeral.

Referring to FIG. 8A, in the case where the presence source #1 is an autonomous-notification-type presence source, when a state change occurs, such as when original presence information regarding an element in the presence source #1 changes (step S201), the presence source #1 autonomously sends a notification of the original presence information which has changed to the presence obtaining unit 101-1 (step S202). Therefore, the presence obtaining unit 101-1 can obtain the original presence information simply by connecting to the presence source #1. Thereafter, the converter 102-1 converts the data format of the individual ID and state (steps S203 and S204). The common ID and primary presence information obtained by conversion are saved in the primary presence storage unit 103-1 (step S205), and a notification stating that the processing of obtaining the primary presence information is successfully completed is sent to the presence source #1 (step S206).

In contrast, referring to FIG. 8B, in the case where the presence source #2 is a reference-type presence source, when a state change occurs, such as when original presence information regarding an element in the presence source #2 changes (step S201), the presence source #2 sends no notification of the original presence information which has changed to the presence obtaining unit 101-2. Therefore, the presence obtaining unit 101-2 periodically refers to the presence source #2 at the connection destination. That is, the presence source #2 is asked whether or not a state change has occurred since the last time a reference was made (step S251). If a state change has occurred, a notification of the original presence information which has changed is sent from the presence source #2 to the presence obtaining unit 101-2 (step S252). Alternatively, if there has been no state change, the presence obtaining unit 101-2 is notified thereof. Hereinafter, as is the case of the above-described autonomous-notification-type presence source, the data format is converted and saved (steps S203 to step S205).

In this manner, the operation of collecting original presence information differs depending on the type of presence source. The presence combining apparatus 100 according to the present embodiment can easily absorb differences among presence sources since the presence combining apparatus 100 includes the presence obtaining units 101-1 to 101-n which are unique to the individual presence sources #1 to #n, respectively.

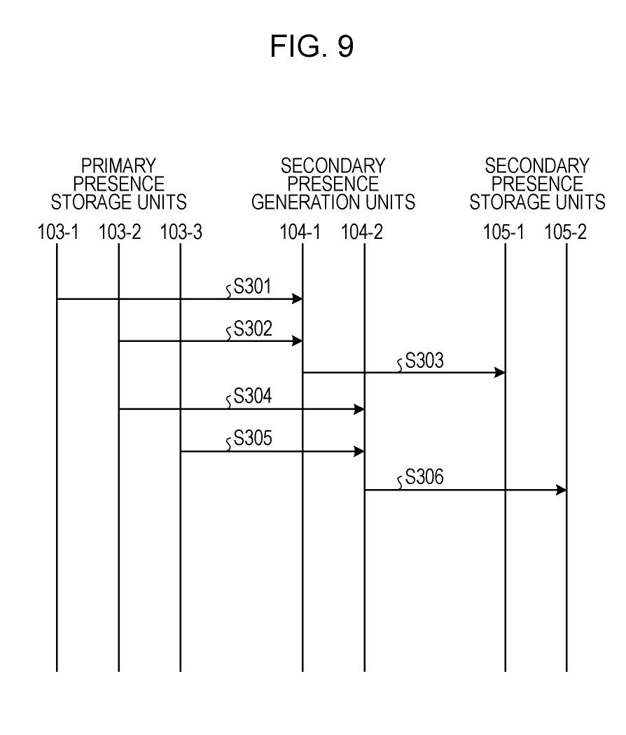

Next, a detailed exemplary operation of generating secondary presence information will be described with reference to the sequence diagram shown in FIG. 9. It is assumed here that the presence combining apparatus 100 includes the primary presence storage units 103-1 to 103-3, and the secondary presence generation unit 104-1 generates secondary presence information from primary presence information stored in the primary presence storage units 103-1 and 103-2.

When generating secondary presence information, the secondary presence generation unit 104-1 reads primary presence information stored in the presence table from the primary presence storage unit 103-1 (step S301). Similarly, the secondary presence generation unit 104-1 reads primary presence information stored in the presence table from the primary presence storage unit 103-2 (step S302). These read items of primary presence information are combined by the secondary presence generation unit 104-1 by applying a secondary presence generation rule, thereby generating secondary presence information. The generated secondary presence information is output and stored in the secondary presence storage unit 105-1 (step S303).

When generating secondary presence information, the secondary presence generation unit 104-2 reads primary presence information from the primary presence storage unit 103-2 (step S304) and reads primary presence information from the primary presence storage unit 103-3 (step S305). These read items of primary presence information are combined by the secondary presence generation unit 104-2 by applying a secondary presence generation rule, thereby generating secondary presence information. The generated secondary presence information is output and stored in the secondary presence storage unit 105-2 (step S306).

Here, since the primary presence information stored in the primary presence storage unit 103-2 is needed by both the secondary presence generation units 104-1 and 104-2, the primary presence storage unit 103-2 is read in an overlapping manner. However, because the times at which the secondary presence generation units 104-1 and 104-2 read the primary presence storage unit 103-2 are different, reading operations of the two do not collide with each other. As a result, the secondary presence generation units 104-1 and 104-2 can reliably read primary presence information needed for generating secondary presence information.

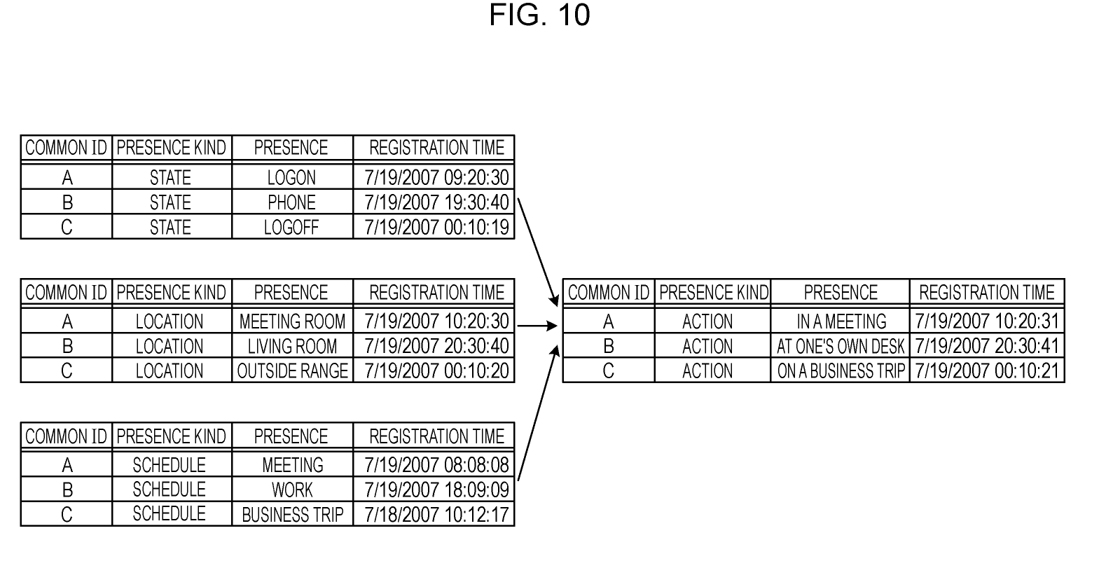

When all items of primary presence information needed are read in this manner, items of primary presence information having the same common ID are integrated, and, for example, as shown in FIG. 10, new presence information (secondary presence information) is generated for each common ID. In the example shown in FIG. 10, secondary presence information indicating the current action of each element is generated from items of primary presence information indicating the network log-on state, location information, and schedule of each element.

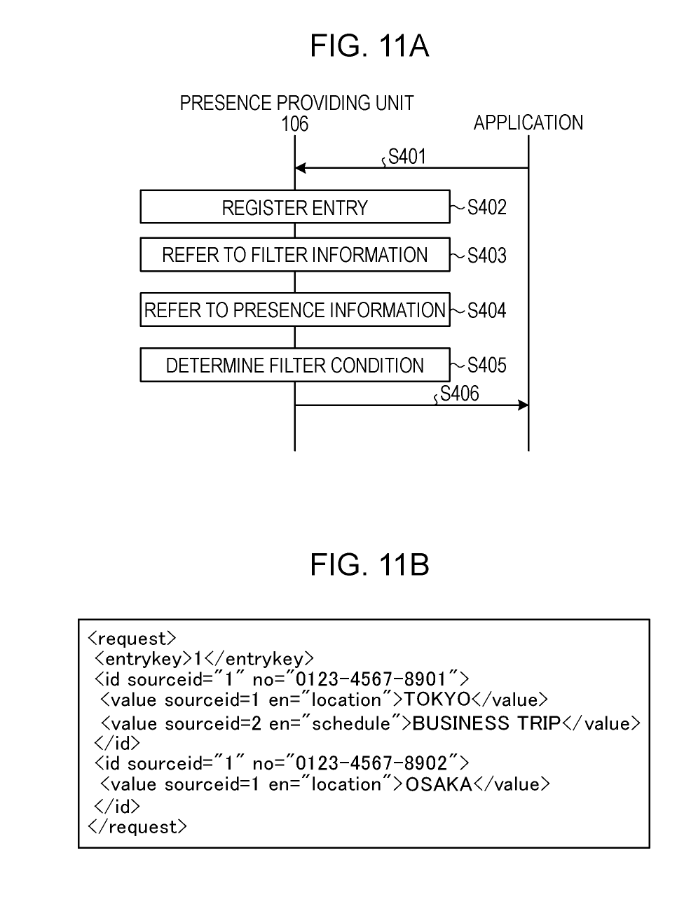

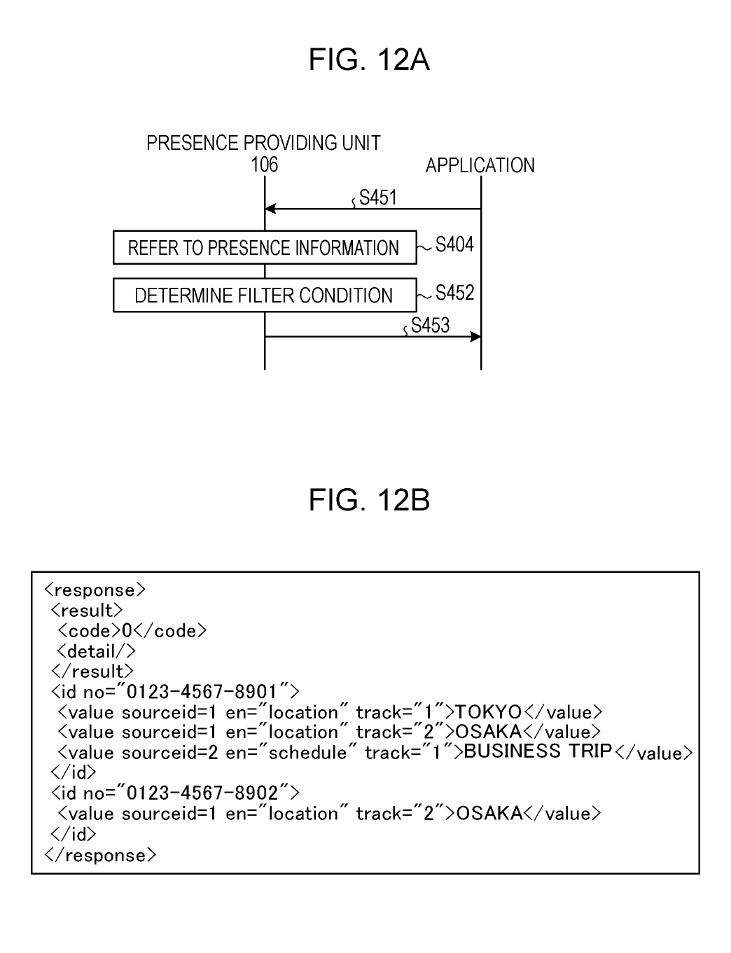

Next, a difference between the case where the presence providing unit 106 refers to presence information in an asynchronous manner and the case where the presence providing unit 106 refers to presence information in a synchronous manner will be described with reference to FIGS. 11A, 11B, 12A, and 12B. FIGS. 11A and 11B illustrate the case where reference is made to presence information in an asynchronous manner using the above-described filter information table. FIGS. 12A and 12B illustrate the case where reference is made to presence information in a synchronous manner without using the filter information table.

In the case where presence information is referred to in an asynchronous manner, as illustrated in FIG. 11A, when filter information sent from an application is received by the presence providing unit 106 (step S401), this filter information is registered in an entry in the filter information table in the presence providing unit 106 (step S402). The presence providing unit 106 refers to each entry in the filter information table (step S403) and refers to presence information stored in each presence storage unit at a monitoring cycle of each entry (step S404). It is determined whether each item of presence information referred to matches the filter condition on an entry-by-entry basis (step S405), and presence information that matches any of the filter conditions is provided to a corresponding application (step S406).

On this occasion, the presence information provided to the application is written in, for example, an XML format, as shown in FIG. 11B. In this example, “<entrykey>1</entrykey>” indicates the entry number in the filter information table. The “id” tag indicates identification information of an element whose presence has changed using an individual ID. That is, for example, “<id sourceid=“1” no=“0123-4567-8901”>” indicates the individual ID “0123-4567-8901” in the presence source whose “sourceid” is “1”. Also, “<value sourceid=1 en=“location”>Tokyo</value>” indicates that the presence of the presence kind “location” in the presence table whose “sourceid” is “1” has become “Tokyo”. Therefore, in this example, the application is notified of, regarding the element whose individual ID is “0123-4567-8901”, a change to “Tokyo” of the presence of the presence kind “location” in the presence table whose “sourceid” is “1”, and a change to “on a business trip” of the presence of the presence kind “schedule” in the presence table whose “sourceid” is “2”, and, regarding the element whose individual ID is “0123-4567-8902”, a change to “Osaka” of the presence of the presence kind “location” in the presence table whose “sourceid” is “1”.

In contrast, in the case where presence information is referred to in a synchronous manner, as illustrated in FIG. 12A, when filter information sent from an application is received by the presence providing unit 106 (step S451), immediately thereafter, reference is made to presence information stored in each presence storage unit (step S404). Here, in the case where presence information is referred to in a synchronous manner, the number of records of presence information needed to be obtained is included in the filter information.

It is determined whether each item of presence information referred to matches the filter condition. Here, by referring to the registration time corresponding to presence information that matches the filter condition, items of presence information equivalent to the number of records are sequentially obtained, starting with the latest item of presence information (step S452), and are provided to the application (step S453). That is, in the case where presence information is referred to in a synchronous manner, a notification of items of past presence information that match the filter condition is sent to the application at the same time.

On this occasion, the presence information provided to the application is written in, for example, an XML format, as shown in FIG. 12B. In this example, the “result” tag indicates whether making reference to presence information has been successfully completed or not. When “code” is a number other than “0”, it is indicated that an error has occurred. Therefore, the application can determine, on the basis of the “result” tag, the reliability of presence information, a notification of which is sent from the presence combining apparatus 100. Also, the “track” parameters represent the order of records of the presence information. In this example, since the “track” parameters are “<value sourceid=1 en=“location” track=“1”>Tokyo</value>” and “<value sourceid=1 en=“location” track=“2”>Osaka</value>”, the presence of the presence kind of this element has changed from “Osaka” to “Tokyo”.

In the present embodiment, since presence information can be referred to both in an asynchronous manner and a synchronous manner, the presence providing unit 106 can refer to presence information in an asynchronous and/or synchronous manner in accordance with the details of processing of the application. That is, when the details of processing of the application require real-time processing, presence information may be referred to in a synchronous manner, for example.

As above, according to the present embodiment, items of presence information are obtained from a plurality of different presence sources using protocols and data formats that are supported by the individual presence sources. The items of presence information are converted into common IDs that do not depend on the presence sources. Additionally, the data formats are converted into a common data format. Secondary presence information is generated from items of primary presence information in the common format, which are obtained by the conversion. Primary presence information and secondary presence information that match a filter condition designated by an application are extracted and provided to the application. Therefore, even when the presence sources have different protocols and data formats, all items of presence information can be handled and combined in the same way. In other words, items of presence information can be efficiently collected from a plurality of different presence sources and can be combined in a format that can be easily employed by an application.

### Second Embodiment

A feature of a second embodiment of the present invention resides in generating secondary presence information by using, when updating of primary presence information in any presence table is detected, a difference between the un-updated and updated items of primary presence information and related primary presence information in the presence table.

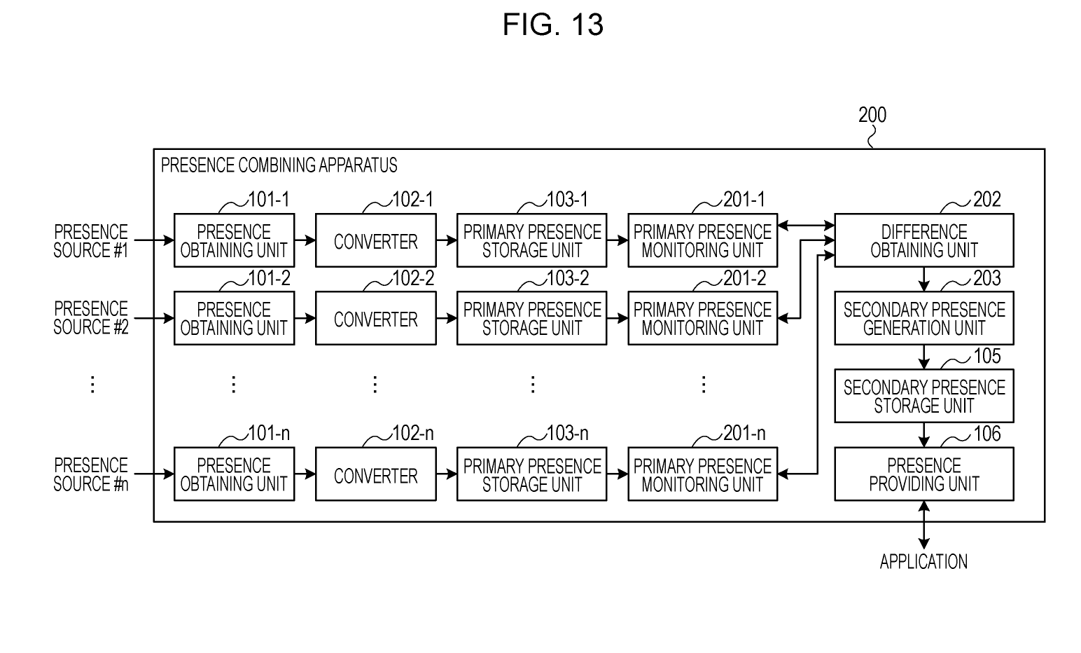

FIG. 13 is a block diagram illustrating a structure of main portions of a presence combining apparatus 200 according to the present embodiment. Referring to FIG. 13, the same portions as those in FIG. 1 are given the same reference numerals, and descriptions thereof are omitted. The presence combining apparatus 200 illustrated in FIG. 13 includes presence obtaining units 101-1 to 101-n, converters 102-1 to 102-n, primary presence storage units 103-1 to 103-n, primary presence monitoring units 201-1 to 201-n, a difference obtaining unit 202, a secondary presence generation unit 203, a secondary presence storage unit 105, and a presence providing unit 106.

The primary presence monitoring units 201-1 to 201-n periodically monitor primary presence information stored in the primary presence storage units 103-1 to 103-n, respectively. When an update of primary presence information is detected, the primary presence monitoring units 201-1 to 201-n send a notification of the update to the difference obtaining unit 202 and output a difference between the un-updated and updated primary presence information to the difference obtaining unit 202. Specifically, the primary presence monitoring units 201-1 to 201-n refer to the registration time of each item of primary presence information in the presence tables held in the primary presence storage units 103-1 to 103-n, respectively. When primary presence information whose registration time has been registered after the last monitoring time is detected, the primary presence monitoring units 201-1 to 201-n determine that this primary presence information has been updated. On this occasion, there is a possibility that a plurality of items of primary presence information has been updated.

In accordance with an instruction from the difference obtaining unit 202, the primary presence monitoring units 201-1 to 201-n output, to the difference obtaining unit 202, primary presence information at a point at which updating has been detected by other primary presence monitoring units 201-1 to 201-n. The primary presence information output here is primary presence information used, together with the updated primary presence information, in order to generate secondary presence information.

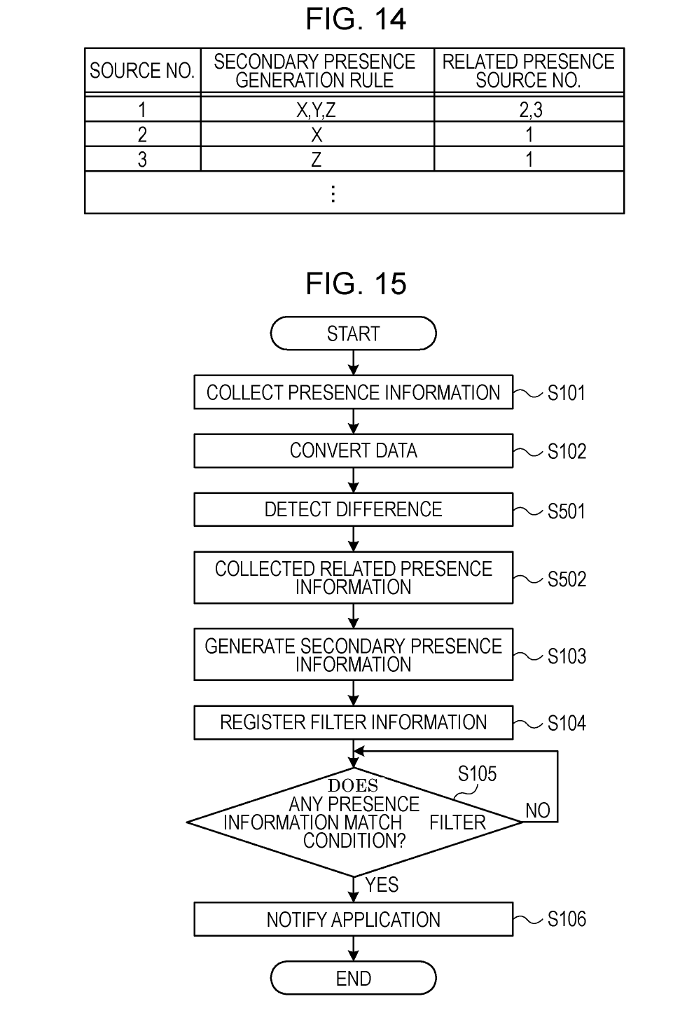

Upon receipt of a notification of updating of the primary presence information from the primary presence monitoring units 201-1 to 201-n, the difference obtaining unit 202 specifies related presence information that is used at the same time as this primary presence information to generate secondary presence information, and instructs the primary presence monitoring units 201-1 to 201-n corresponding to the related presence information to obtain primary presence information. Specifically, the difference obtaining unit 202 may include, for example, a table similar to the related presence source table illustrated in FIG. 14. For each of the presence sources of primary presence information stored in the primary presence storage units 103-1 to 103-n, a secondary presence generation rule to be applied and a presence source of related presence information used at the same time to generate secondary presence information are stored in the difference obtaining unit 202.

That is, the example shown in FIG. 14 illustrates that, for example, primary presence information stored in the primary presence storage unit 103-1 is used together with primary presence information stored in the primary presence storage units 103-2 to 103-3 to generate secondary presence information by applying three secondary presence generation rules “X, Y, and Z”. Therefore, when the primary presence monitoring unit 201-1 detects that primary presence information stored in the primary presence storage unit 103-1 has been updated, the difference obtaining unit 202 instructs the primary presence monitoring units 201-2 and 201-3 to obtain the primary presence information. On this occasion, in order to prevent the primary presence monitoring units 201-2 and 201-3 from detecting the updating of the primary presence information, the difference obtaining unit 202 may instruct the primary presence monitoring units 201-2 and 201-3, which have not detected the updating, to temporarily stop monitoring the primary presence information, and then instruct the primary presence monitoring units 201-2 and 201-3 to obtain the primary presence information.

The secondary presence generation unit 203 combines the items of primary presence information obtained by the difference obtaining unit 202 at the time at which the updating has occurred, whereby secondary presence information is generated. A specific method of generating secondary presence information, which is performed by the secondary presence generation unit 203, is similar to the case of the secondary presence generation units 104-1 and 104-2 in the first embodiment. Items of primary presence information are combined in accordance with the secondary presence generation rules.

Next, a presence combining process performed by the presence combining apparatus 200 structured as described above will be described with reference to the flowchart shown in FIG. 15. In FIG. 15, the same portions as those in FIG. 7 are given the same reference numerals, and detailed descriptions thereof are omitted.

The presence obtaining units 101-1 to 101-n collect items of original presence information from the individual presence sources #1 to #n (step S101). The items of original presence information obtained by the presence obtaining units 101-1 to 101-n are converted by the converters 102-1 to 102-n into items of primary presence information having common IDs and a common data format that can be commonly used (step S102). Primary presence information obtained by conversion into the common format in this manner is stored in the presence tables in the primary presence storage units 103-1 to 103-n.

In contrast, the primary presence monitoring units 201-1 to 201-n monitor the presence tables in the primary presence storage units 103-1 to 103-n, respectively. When primary presence information in a given presence table is updated, a primary presence monitoring unit that corresponds to the given presence table detects a difference in the primary presence information (step S501). The primary presence monitoring unit which has detected the difference sends a notification of detection of the difference to the difference obtaining unit 202 and outputs the primary presence information, of which the actual difference has been detected, to the difference obtaining unit 202. Since the related presence source table is held in the difference obtaining unit 202, when the difference obtaining unit 202 receives a notification of detection of a difference from any primary presence monitoring unit, the difference obtaining unit 202 specifies related presence information relating to the primary presence information, of which the difference has been detected.

The difference obtaining unit 202 instructs the primary presence monitoring unit corresponding to the related presence information to collect the primary presence information. As a result, the instructed primary presence monitoring unit obtains the related presence information at a point at which the other primary presence information has been updated, and is collected in the difference obtaining unit 202 (step S502). The related presence information collected in this manner is primary presence information used together with the updated primary presence information to generate secondary presence information. The related presence information is used to generate all items of secondary presence information affected by the updating of the primary presence information. In the present embodiment, only related primary presence information is collected when any item of primary presence information is updated. Therefore, the frequency of accessing the primary presence storage units 103-1 to 103-n can be reduced, and loads on the primary presence storage units 103-1 to 103-n can be suppressed. This point will be described in detail below.

When all items of primary presence information needed to generate secondary presence information are collected by the difference obtaining unit 202, the secondary presence generation unit 203 applies the secondary presence generation rule to generate secondary presence information by combining the items of primary presence information (step S103). Hereinafter, as in the first embodiment, filter information is received by the presence providing unit 106 from an application and entered into the filter information table (step S104). The presence providing unit 106 monitors primary presence information and secondary presence information stored in the primary presence storage units 103-1 to 103-n and the secondary presence storage unit 105 (step S105). When presence information that matches the filter condition is detected (YES in step S105), the presence providing unit 106 obtains the corresponding presence information. The presence providing unit 106 sends a notification of the obtained presence information to the application (step S106).

Accordingly, the application can obtain items of unique presence information in a plurality of different presence sources using a unified, common format. Additionally, the application can obtain higher-order presence information generated by combining two or more items of primary presence information. As a result, the application can execute various processes simply by using the obtained presence information. When primary presence information has been updated, the difference obtaining unit 202 collects the most recent primary presence information and thereafter generates secondary presence information by using the updated primary presence information. Therefore, the secondary presence information can be kept in the most recent state.

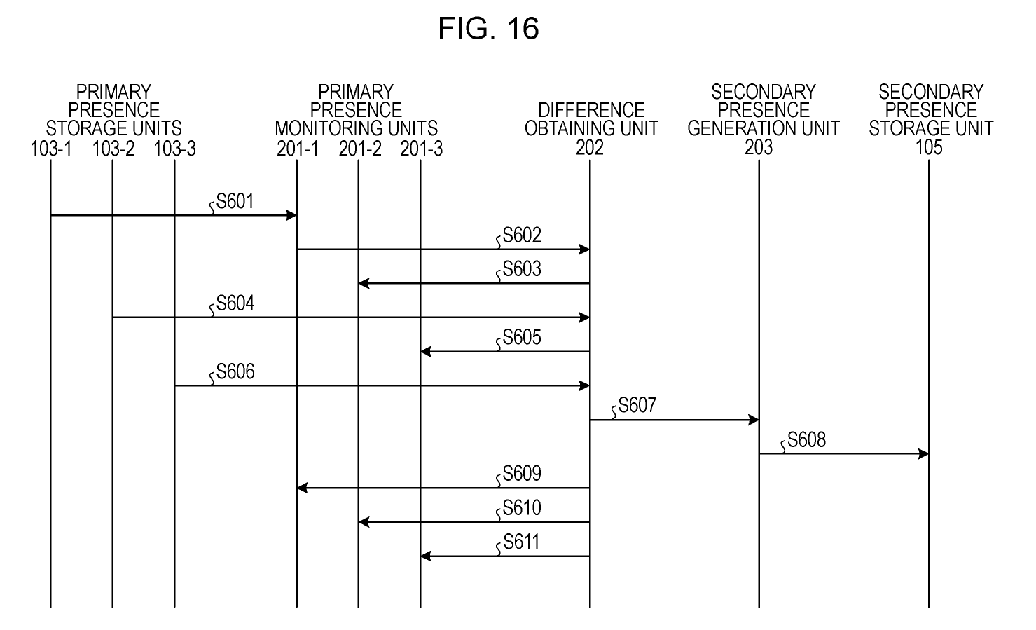

Next, a detailed exemplary operation of generating secondary presence information will be described with reference to the sequence diagram illustrated in FIG. 16. It is assumed here that the presence combining apparatus 200 includes the primary presence storage units 103-1 to 103-3 and the primary presence monitoring units 201-1 to 201-3.

In the present embodiment, the primary presence monitoring units 201-1 to 201-3 periodically monitor the primary presence storage units 103-1 to 103-3, respectively. For example, when primary presence information stored in the primary presence storage unit 103-1 has been updated since the last monitoring time, difference data between the un-updated and updated primary presence information is read out to the primary presence monitoring unit 201-1 (step S601). The primary presence monitoring unit 201-1 sends a notification of updating of the primary presence information and the actual difference data to the difference obtaining unit 202 (step S602).

The difference obtaining unit 202 refers to the related presence source table and specifies related presence information relating to the primary presence storage unit 103-1 in which the updating has been performed. That is, primary presence information to be used together with the updated presence information in the primary presence storage unit 103-1 to generate secondary presence information is specified. It is assumed here that the primary presence information stored in the primary presence storage units 103-2 and 103-3 is related presence information.

The difference obtaining unit 202 instructs the primary presence monitoring unit 201-2 corresponding to the related presence information to obtain the primary presence information (step S603). In order to prevent overlapping detection of updating of the related presence information, this obtaining instruction includes an instruction for the primary presence monitoring unit 201-2 to temporarily stop monitoring. The instructed primary presence monitoring unit 201-2 reads the primary presence information from the primary presence storage unit 103-2 and transfers the primary presence information to the difference obtaining unit 202 (step S604).

Similarly, the difference obtaining unit 202 instructs the primary presence monitoring unit 201-3 corresponding to the related presence information to obtain the primary presence information (step S605). This obtaining instruction also includes an instruction for the primary presence monitoring unit 201-3 to temporarily stopmonitoring. The instructed primary presence monitoring unit 201-3 reads the primary presence information from the primary presence storage unit 103-3 and transfers the primary presence information to the difference obtaining unit 202 (step S606).

In this manner, in the present embodiment, when primary presence information is updated in any primary presence storage unit, related presence information is collected from a minimum presence tables required for updating secondary presence information. Therefore, the frequency of accessing the primary presence storage units 103-1 to 103-n can be reduced, and loads on the primary presence storage units 103-1 to 103-n can be suppressed. That is, access to the primary presence storage units 103-1 to 103-n only involves two types: access at the time of periodical monitoring performed by the primary presence monitoring units 201-1 to 201-n; and access at the time of updating related primary presence information.

With the above-described process, while loads on the primary presence storage units 103-1 to 103-n are suppressed, the updated primary presence information and all items of related presence information to be used together with this primary presence information to generate secondary presence information are collected in the difference obtaining unit 202. The secondary presence generation unit 203 reads the primary presence information collected in the difference obtaining unit 202 (step S607) and generates new secondary presence information on the basis of the updated primary presence information. The generated secondary presence information is output and stored in the secondary presence storage unit 105 (step S608).

In contrast, since the primary presence monitoring units 201-1 to 201-3 have temporarily stopped monitoring, after the secondary presence generation unit 203 reads the primary presence information, the difference obtaining unit 202 gives instructions for the primary presence monitoring units 201-1 to 201-3 to resume monitoring (steps S609 to S611).

As above, according to the present embodiment, when primary presence information has been updated, only the updated primary presence information and primary presence information relating to generation of secondary presence information are collected to update the secondary presence information. Therefore, the frequency of accessing presence tables storing primary presence information can be reduced, and loads thereon can be suppressed.

Note that, in the foregoing embodiments, the presence combining apparatuses 100 and 200 execute the presence combining process. Alternatively, the presence combining process may be written in a computer-readable programming language, and the obtained presence combining program may be executed on a computer, thereby realizing a presence combining process similar to that of the foregoing embodiments. In this case, the presence combining program may be recorded on a recording medium, such as a compact-disc read-only memory (CD-ROM), and installed in the computer.

As has been described above, according to the presence combining apparatus, and the presence combining method disclosed herein, items of presence information can be efficiently collected from a plurality of different presence sources and converted into a format that can be easily employed by an application.

What is claimed is:

1. A presence combining apparatus comprising: collecting means for collecting the items of presence information managed in formats of the individual presence sources by connecting individually to a plurality of different presence sources that manage items of presence information indicating states of elements;
converting means for converting the items of presence information collected by the collecting means into items of primary presence information in a common format that does not depend on the presence sources;
storage means for storing the items of primary presence information obtained by conversion performed by the converting means; and
generation means for generating secondary presence information by combining the items of primary presence information, which are stored by the storage means, in accordance with a given rule.

2. The presence combining apparatus according to claim 1, wherein the collecting means collects items of presence information storing identification information of the elements and the states of the elements in unique formats of the individual presence sources, and
wherein the converting means converts the identification information of the elements into items of common identification information that do not depend on the presence sources, separates the states of the elements into items of state kind information and items of actual state information, thereby converting the items of presence information into items of primary presence information.

3. The presence combining apparatus according to claim 2, wherein the converting means converts items of identification information of the same element or a pair of elements, which have been obtained from different presence sources, into the same common identification information.

4. The presence combining apparatus according to claim 1, wherein the collecting means collects items of presence information, notifications of which are autonomously sent from the individual presence sources.

5. The presence combining apparatus according to claim 1, wherein the collecting means periodically refers to the individual presence sources and collects presence information which has changed since the previous reference time.

6. The presence combining apparatus according to claim 1, further comprising providing means for providing primary presence information or secondary presence information that matches a condition designated by an external application.

7. The presence combining apparatus according to claim 6, wherein the providing means includes a condition table holding the condition designated by the external application in association with an expiration date before which the condition is effective, and
wherein, before the expiration date of the condition held in the condition table, when there is primary presence information or secondary presence information that matches the condition, the providing means provides the primary presence information or secondary presence information to the application.

8. The presence combining apparatus according to claim 6, wherein the providing means receives the condition designated by the external application and the number of records indicating the number of items of required past presence information, and, when there is primary presence information or secondary presence information that matches the received condition, provides to the application items of the primary presence information or secondary presence information equivalent to the number of records, starting with the most recent item.

9. The presence combining apparatus according to claim 1, wherein the generation means comprises:
monitoring means for monitoring whether the primary presence information stored by the storage means has been updated or not; and
obtaining means for obtaining, from the storage means, when an update of the primary presence information is detected by the monitoring means, the updated primary presence information and related presence information to be combined with the updated primary presence information, and
wherein the generation means generates secondary presence information from the updated primary presence information and the related presence information obtained by the obtaining means.

10. The presence combining apparatus according to claim 9, wherein the monitoring means temporarily stops monitoring the related presence information while the related presence information is being obtained by the obtaining means.

11. A presence combining method comprising:
a collecting step of collecting the items of presence information managed in formats of the individual presence sources by connecting individually to a plurality of different presence sources that manage items of presence information indicating states of elements;
a converting step of converting the items of presence information collected in the collecting step into items of primary presence information in a common format that does not depend on the presence sources; and
a generation step of generating secondary presence information by combining the items of primary presence information, which are obtained by conversion performed in the converting step, in accordance with a given rule.
